(19) United States
(12) Patent Application Publication
(10) Pub. No.: US 2011/0214823 A1
(43) Pub. Date: Sep. 8, 2011

(54) Window Blind with Blind Controlling Arrangement

(75) Inventors: Wem-Hsing Hu, Changhua County (TW); Sheng-Ying Hsu, Changhua County (TW)

(73) Assignee: CHING FENG HOME FASHIONS CO., LTD., Changhua County (TW)

(21) Appl. No.: 12/715,395

(22) Filed: Mar. 2, 2010

(51) Int. Cl. E06B 9/30

(52) U.S. Cl. 160/168.1 R

(57) ABSTRACT

The window blind includes a plurality of blind elements spacedly supported between upper and lower supports and configured to have a plurality of stationary blinds and a plurality of adjustable blinds alternating with the stationary blinds, and a blind controlling arrangement including a first controlling cord set, a second controlling cord set, and a plurality of control members selectively coupling with the first controlling cord to retain the adjustable blinds in position in responsive to the first controlling cord. When the first controlling cord is pulled, only the adjustable blinds are upwardly lifted to adjust a relative distance between the stationary blind and adjustable blind, so as to adjust a light permitting range therebetween.

### BACKGROUND OF THE PRESENT INVENTION

1. Field of Invention

The present invention relates to window blind for adjustably controlling an indoor light intensity or light effect therethrough, especially to the window blind which is able to control the displacement of selected blind elements for adjusting the light entering into the indoor area through the gaps between the blind elements.

2. Description of Related Arts

The existing window blind generally comprises a controlling cord extending through a lower supporting frame, a plurality of blinds, an upper supporting frame, and a controlling unit provided at the upper supporting frame for controllably the vertical displacement of the blinds via the controlling cord.

Accordingly, the controlling cord is able to adjustably control the rotational angle of each of the blinds for blocking the light entering into the indoor through the intervals between the blinds to keep out the light, or let the light in through the intervals between two neighboring blinds. However, the controlling cord of the controlling unit is rotatably coupled at the pivot points of each of the blinds for rotatably adjusting the rotational angles thereof, so that the maximum rotational angle of the blinds is the maximum light permitting space between two blinds for letting in the light. Thus, the maximum light permitting space is limited between the pitches or gaps of two neighboring horizontal blinds, and can hardly be further increased. Therefore, permitting light space via the blinds of the window blind is limited by the rotational angle of the blinds, so as to limit the light permitting patterns of the light coming through the window blind.

### SUMMARY OF THE PRESENT INVENTION

According to the existing disadvantages of the window cover, the present invention provides a window blind with blind controlling arrangement, which is simple in structure. Through simply controlling each of the blind elements of the window blind via the controlling cord, a desired number of blind elements can be controllably adjusted to selectively adjust the light permitting range thereof.

In order to accomplish the above objective, the window blind with blind controlling arrangement of the present invention comprises an upper support, a lower support, a plurality of blind elements located between the upper support and the lower support, and a blind controlling arrangement which comprises a first controlling cord set and a second controlling cord set for adjustably controlling all the blind elements to move between an unfolded position and a folded position.

The blind elements are configured to include a plurality of stationary blinds and a plurality of adjustable blinds, wherein the stationary blinds and the adjustable blinds preferably have the substantially identical size and shape. Two cord through holes, having an elongated shape, are provided at two end portions of each of the stationary blinds and adjustable blinds respectively. The stationary blinds and the adjustable blinds are spacedly supported between the upper and lower supports in an alternating manner. Each of the first and second controlling cord sets is configured to have an inverted U-shaped structure that two vertical portions of each of the first and second controlling cord sets are extended through the cords through holes of the stationary and adjustable blinds from the upper support.

The first and second controlling cord sets extended through the cord through holes are configured to extend therewithin in tandem manner at a position that the first controlling cord set is preferably located at the front portion of each of the cord through holes while the second controlling cord set is preferably located at the rear portion of each of the cord through holes. The bottom free end of the first controlling cord set is affixed to the bottommost adjustable blind. The bottom free end of the second controlling cord set is affixed to the lower support. The other controlling ends of the first and second controlling cord sets are extended through and out of the upper support for being conveniently and adjustably operated by a hand of user.

The blind controlling arrangement further comprises a plurality of control members supported at the bottom sides of the adjustable blinds at the cord through holes thereof respectively, wherein each of the control members has a clipping aperture which is adapted to elastically and flexibly adjust the diameter size thereof coupling with the first controlling cord set. Therefore, through a pulling force applied at the first controlling cord set at the controlling end thereof, a displacement of each of the adjustable blinds is able to be controllably adjusted via the first set of the controlling cord to selectively adjust a relative distance between the stationary and adjustable blinds, so as to adjust the light permitting range therebetween.

Accordingly, the present invention has the following advantages.

The blind elements of the present invention are arranged to have the stationary and adjustable blinds, wherein through the controlling cord set and the control member supportively located at the bottom side of the adjustable blinds, different light effects of the window blind can be selectively achieved. When the controlling cord is downwardly pulled, the controlling cord is able to control the control member and the adjustable blinds being supported thereat to actuate the displacement of the adjustable blinds, so as to adjust the light permitting rang between the stationary and adjustable blinds. The stationary blinds and the adjustable blinds are alternatively arranged, so that no matter one or two stationary blinds are provided in between two corresponding adjustable blinds, the displacement of the adjustable blinds related to the stationary blinds is able to be increased to form variety of the light permitting ranges between the blind elements. Therefore, the distance between the stationary blinds and the adjustable blinds is able to be adjustably formed variety larger or smaller light permitting ranges, so that the user is able to selectively control the light coming into the indoor through the window blind, so as to break through the inherent configuration of traditional window blind.

These and other objectives, features, and advantages of the present invention will become apparent from the following detailed description, the accompanying drawings, and the appended claims.

### BRIEF DESCRIPTION OF THE DRAWINGS

FIG. 1 is a front view of a window blind according to a preferred embodiment of the present invention.

FIG. 2 is a perspective view of the control member incorporating with the adjustable blind of the blind element of the window blind according to the preferred embodiment of the present invention.

FIG. 3 is a front view of the window blind according to the preferred embodiment of the present invention, illustrating the adjustment of the light permitting range of the window blind.

FIG. 4 is a perspective view of the control member coupled with the first controlling cord set at the bottom side of the adjustable blind of the window blind according to the preferred embodiment of the present invention.

FIG. 5 illustrates an alternative mode of the control member of the window blind according to the preferred embodiment of the present invention.

FIG. 6 illustrates the alternative mode of the control member coupled with the first controlling cord set at the bottom side of the adjustable blind of the window blind according to the preferred embodiment of the present invention.

FIG. 7 is a front view of the window blind according to the above preferred embodiment of the present invention, illustrating different arrangements of the stationary and adjustable blinds.

FIG. 8 illustrates the adjustment of the light permitting range of the window blind with different arrangements of the stationary and adjustable blinds according to the above preferred embodiment of the present invention.

### DETAILED DESCRIPTION OF THE PREFERRED EMBODIMENT

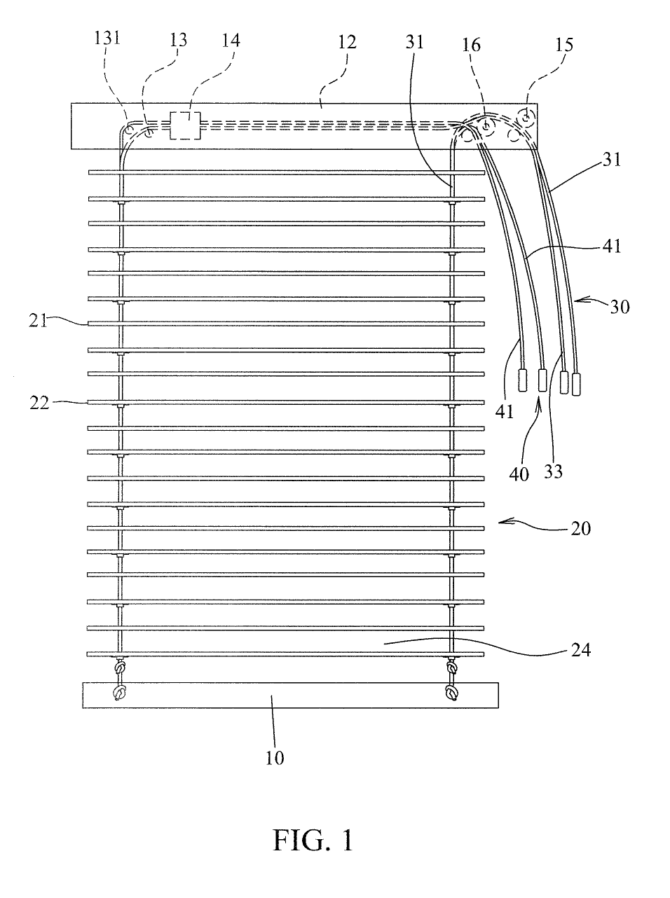

Referring to FIG. 1 of the drawings, a window blind according to a preferred embodiment of the present invention is illustrated, wherein the window blind comprises an upper support 12, a lower support 10, a plurality of blind elements 20 provided between the upper and lower support 12, 10, and a blind controlling arrangement which comprises a first controlling cord set 30 and a second controlling cord set 40.

The window blind further comprises two rotational pillars 13, 131 spacedly supported at the upper support 12 at one side end thereof, a controlling unit 14 supported by the upper support 12 at a position adjacent to the rotational pillars 13, 131. The window blind further comprises two pairs of rotational wheel sets, i.e. a first wheel set 15 and a second wheel set 16 rotatably supported at an opposed side end of the upper support 12. The controlling unit 14 is provided for controlling the displacement of the first controlling cord set 30, so that when a pulling force applied at the first controlling cord set 30 is released, the controlling unit 14 is able to stop and lock the sliding movement of the first controlling cord set 30.

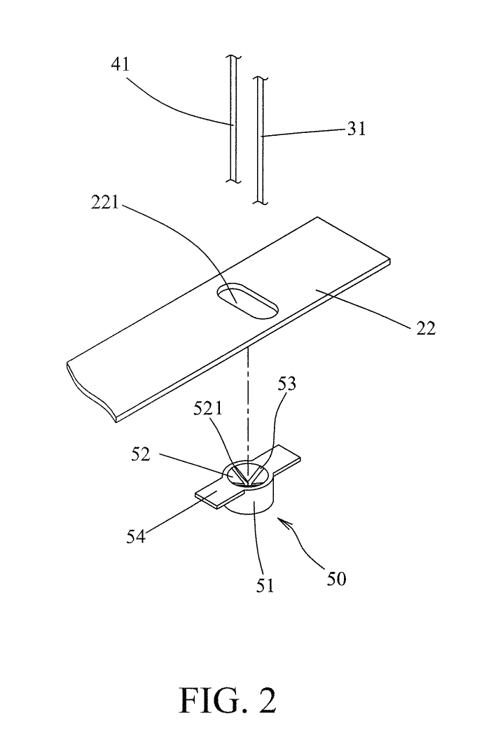

As shown in FIGS. 1 and 2 of the drawings, the blind elements 20 are configured to have a plurality of stationary blinds 21, and a plurality of adjustable blinds 22, wherein the stationary blind 21 and the adjustable blind 22 preferably have the identical shape and size, wherein two elongated cord through holes 221 are provided at two end portions of each of the stationary and adjustable blinds 21, 22. The main feature of the present invention is having two different sets of blind elements, i.e. the stationary blinds 21 and the adjustable blinds 22. The stationary blind 21 and the adjustable blinds 22 are spacedly supported between the upper and lower supports 12, 10 in an alternating manner that the stationary blind 21 and the adjustable blinds 22 are alternatively provided for being arranged to an odd position and even position respective, or vice-versa. The first odd position of the blind element 20 is defined at the first blind element 20 provided above the lower support 10. For example, the stationary blinds 21 of the blind elements 20 may be provided at the first, third, fifth, . . . locations of odd position while the adjustable blinds 22 are provided at the second, fourth, sixth, . . . locations of the even position from the lower support 10 to the upper support 12.

Each of the first and second controlling cord sets 30, 40 of the blind controlling arrangement is configured to have an inverted U-shaped manner that two vertical portions of the first and second controlling cord sets 30, 40 are extended through the blind elements 20 to the upper support 12. The first and second controlling cord sets 30, 40 are configured to extend within the cord through holes in tandem manner, which is overlapping the first controlling cord set 30 with the second controlling cord set 40 in a 2-dimensional front view of the window blind. As shown in FIG. 1 the first and second controlling cord sets 30, 40 are illustrated side-by-side to extend within the cord through holes 221 just for conveniently illustrating both of the first and second controlling cord sets 30, 40 at the same time in the front view of FIG. 1. The first controlling cord set 30 comprises two first controlling cords 31, 33, and the second controlling cord set 40 comprises two second controlling cords 41. The two first controlling cords 31, 33 of the first controlling cord set 30 are upwardly extended through the cord through holes 221 at two end portions of each of the stationary and adjustable blinds 21, 22 to the upper support 12. Accordingly, the first controlling cord set 30 is extended through the upper support 12 to engage with the first rotational pillar 13, the controlling unit 14, and the first wheel set 15 orderly, wherein the controlling end of the first controlling cord set 30 is extended out of the upper support 12 for being operatively pulled to adjustably control the blind elements 20 of the window blind.

The two second controlling cords 41 of the second controlling cord set 40 are upwardly extended from the lower support 10 to the upper support 12 through the blind elements 20, wherein ,the second controlling cord set 40 is extended through the upper support 12 to engage with the second rotational pillar 131, the controlling unit 14, and the second wheel set 16 orderly. The controlling end of the second controlling cord set 40 is extended out of the upper support 12 for being operatively pulled to adjustably control the blind elements 20 of the window blind.

The blind controlling arrangement further comprises a plurality of control members 50 spacedly coupling along the first controlling cord set 30, wherein the control members 50 are located at the adjustable blinds 22 along the first controlling cord set 30. Accordingly, each of the control members 50 comprises a base body 51 having a conical shaped opening 52 formed therewithin, and a plurality of gaps 53 downwardly, radially, and evenly formed at an inner surface of the opening 52, wherein a diameter of the opening 52 is gradually reduced from top to bottom of the base body 51. Each of the control members 50 further has a clipping aperture 521 defined at the minimum diameter of the opening 52 of the base body 51, i.e. the bottom side of the opening 52, wherein the first controlling cord set 30 is coupled at the clipping aperture 521 of each of the control members 50. At least one engaging element 54 is outwardly and horizontally extended from a peripheral edge of the upper end of the base body 51. The engaging element 54 is extended at a direction vertical to a longitudinal direction of the elongated cord through hole 221, so that the engaging element 54 of the control member 50 is able to engage with a bottom side of the corresponding adjustable blind 22 of the blind elements 20 for supporting the adjustable blinds 22 thereat.

Therefore, the control member 50 is supported at the bottom side of the adjustable blind 22 to align with the cord through hole 221 thereof, wherein the control member 50 is supported at the bottom side of the adjustable blind 22 via the engaging element 54 to align the opening 52 with the cord through hole 221. One end of the first controlling cords 31, 33 of the first controlling cord set 30 are alignedly extended through the cord through holes 221 of the adjustable blinds 22 and through the openings 52 of the control members 50. Accordingly, an external force is applied to the control member 50 for stretching out the clipping aperture 521, i.e. increasing the diameter size thereof, for the first controlling cord 31, 33 of the first controlling cord set 30 extending through the clipping aperture 521. After releasing the external force, the clipping aperture 521 is flexibly returned to the original shape thereof to reduce the diameter of the clipping aperture 521 for tightly holding the first controlling cords 31, 33 of the first controlling cord set 30 in position. The first controlling cords 31, 33 are further extended through the cord through hole 221 of the next adjustable blind 22, and the cord through hole 221 of the next stationary blinds 21, and then extended through the next adjustable blind 22 and another control member 50 until the first controlling cords 31, 33 are passing through all of the blind elements 20. The bottom end of the first controlling cords 31, 33 are affixed at the bottom side of the bottommost adjustable blind 22 at a position that the first controlling cords 31, 33 of the first controlling cord set 30 are affixed at the bottom side of the control members 50 at the bottom side of the bottommost adjustable blind 22.

The two second controlling cords 41 of the second controlling cord set 40 are extended through the cord through holes 221 of the stationary blinds 21 and the adjustable blinds 21 at a position that the second controlling cords 41 are parallelly extending to the first controlling cords 31, 33, in such a manner that the first and second controlling cord sets 30, 40 are extended through each of the blind elements 20. (Each of the blind elements 20 are spacedly located between the upper support 12 and the lower support 10 for being supported thereby, wherein the arrangement of the first and second controlling cord sets 30, 40 are similar to the conventional Roman blind, which is not shown in the Figures.) The bottom end of the second controlling cord set 40 is affixed at the lower support 10.

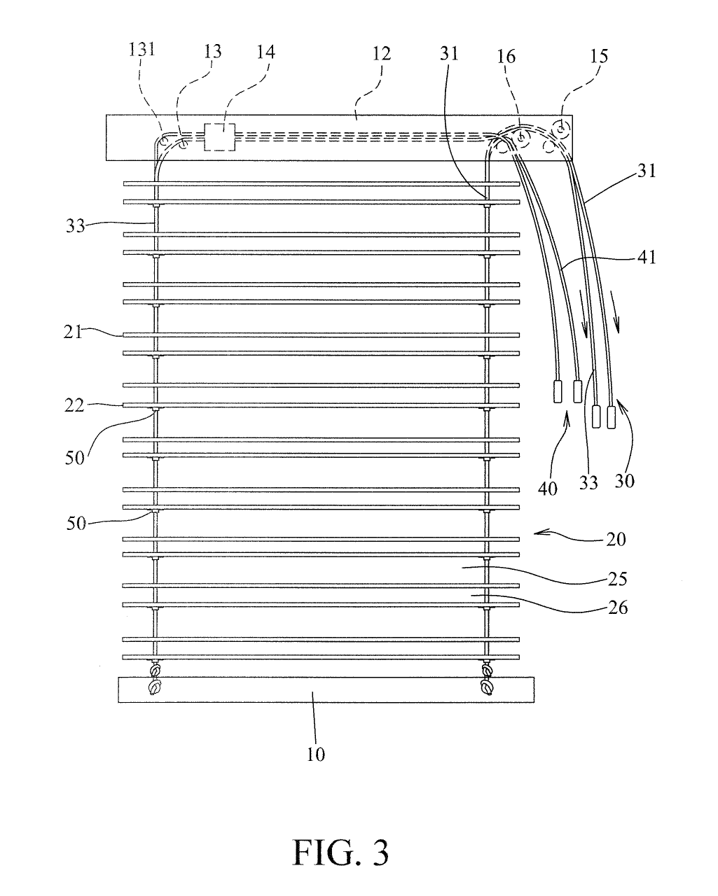

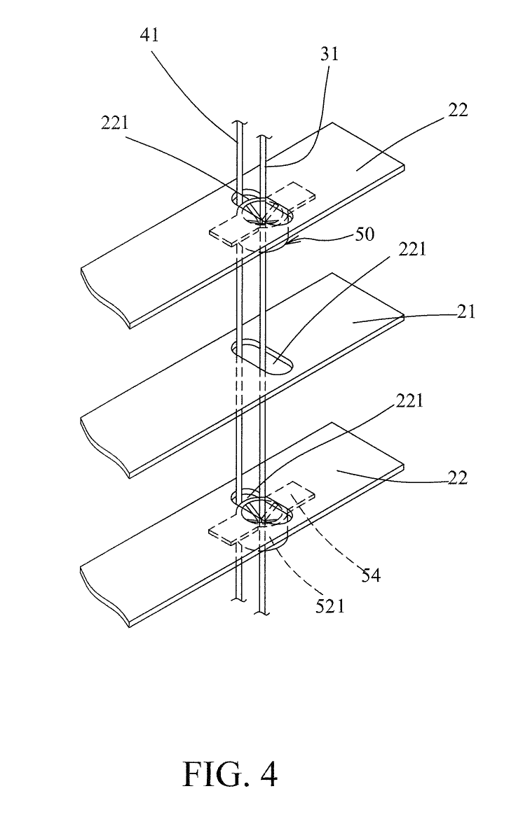

The features of the present invention, as shown in FIGS. 1, 3, and 4, are illustrated as the following. Before the first controlling cord set 30 is pulled to actuate the blind elements 20, the stationary blinds 21 and the adjustable blinds 22 are separated at the same distance therebetween to retain the same light permitting range 24 therebetween. Furthermore, when the user downwardly pulls the first controlling cord set 30 to actuate the controlling ends of the first controlling cords 31, 33 downwardly moved, the adjustable blinds 22 is arranged to upwardly move. Accordingly, when the controlling ends of the first controlling cords 31, 33 are pulled downwardly, the control members 50 are correspondingly moved upwardly to upwardly lift the adjustable blinds 22. Therefore, the distance between the stationary blind 21 and the adjustable blind 22 is selectively adjusted to form variety of light permitting ranges 25, 26. The light permitting range 25 is larger than the light permitting range 24 in the FIG. 1, while the light permitting range 26 is smaller that the light permitting range 24 in the FIG. 1.

Therefore, the distances between the stationary blinds 21 and the adjustable blinds 22 are not the regularly united single light permitting range 24, but have different sizes of the light permitting ranges 25, 26. The larger light permitting range 25 enables adequate light coming into the indoor through the window blind to provide a brighter environment. Thus, the light regulation via the window blind of the present invention is able to provide more diverse and variability light effects.

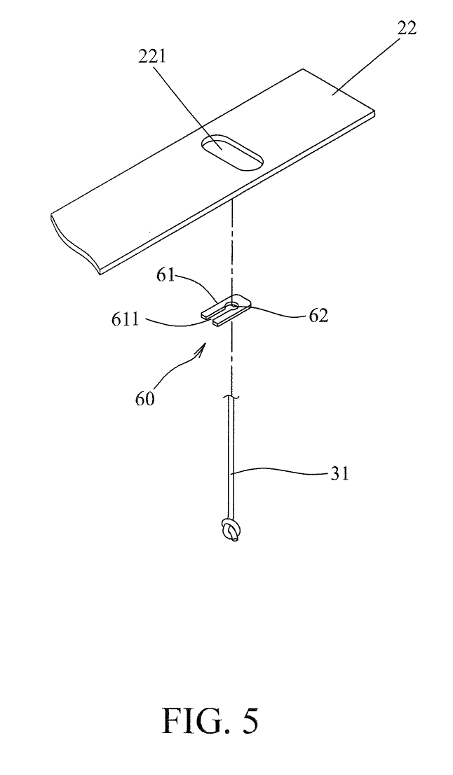

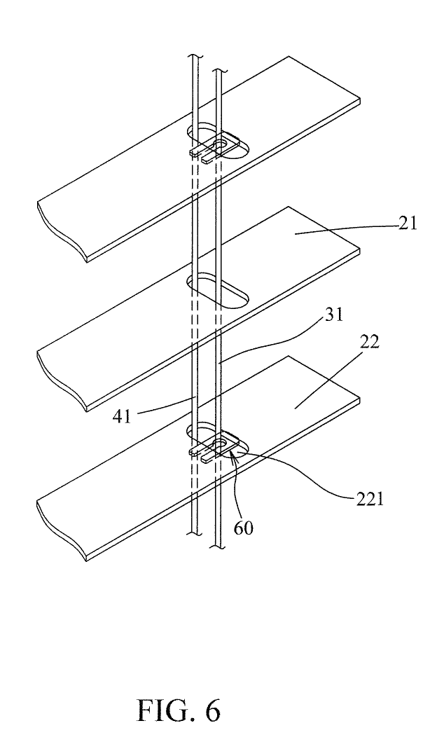

As shown in FIGS. 5 and 6 of the drawings, an alternative control member 60 according to the preferred embodiment of the present invention is illustrated, wherein the control member 60 comprises a U-shaped clipping member 61 having a guiding channel 611 provided thereat, wherein the guiding channel 611 has an opened end formed at a peripheral edge of the clipping member 61 and a closed end extended towards a central portion thereof to define a clipping aperture 62 as the opening of the control member 60 at the closed end of the guiding channel 611. Therefore, the guiding channel 611 is stretched to enlarge the size thereof to allow the first controlling cord set 30 extending through the clipping aperture 62 through the guiding channel 611 by applying an external force for opening the clipping aperture 62 of the clipping member 61. After the external force is released from the clipping member 61, the diameter of the clipping aperture 62 is reduced for clipping and coupling with the first controlling cord 31 at the bottom side of the adjustable blind 22. Therefore, the control member 60 is able to synchronizedly adjust the light permitting range between the adjustable blind 22 and the stationary blind 21 as mentioned in the above preferred embodiment. Otherwise, the adjustable blinds 22 of the blind elements 20 are able to be operatively controlled via the first controlling cord set 30 to return the adjustable blinds 22 to the original position.

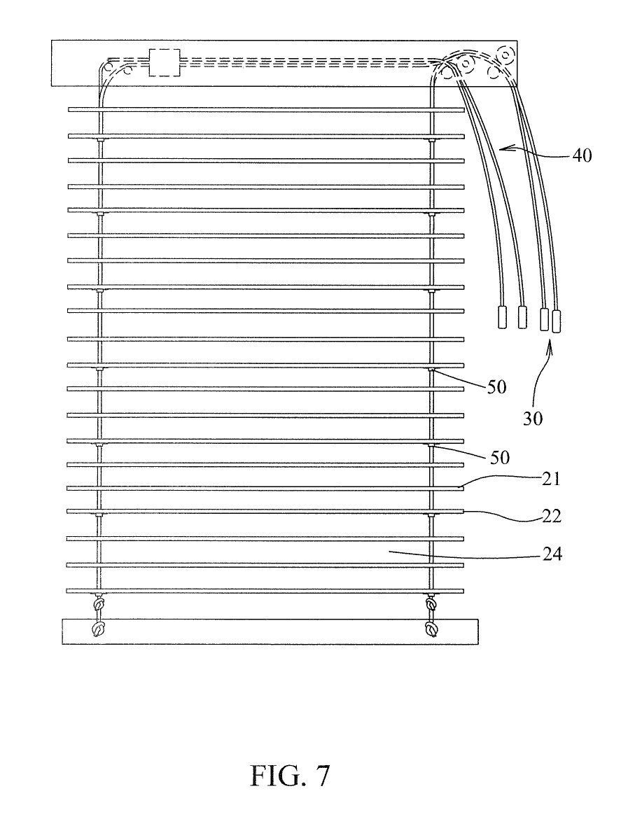

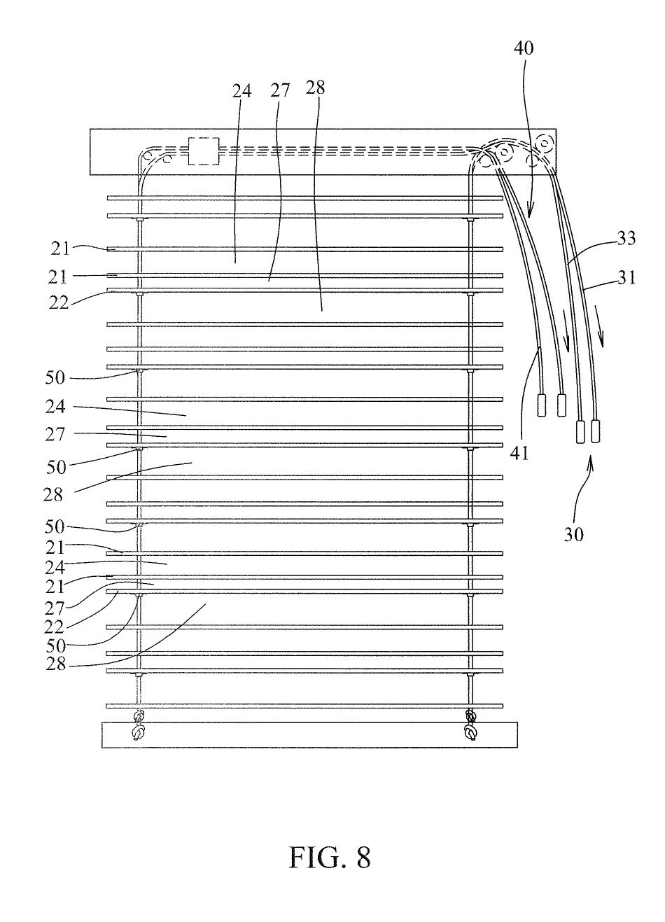

Furthermore, as shown in FIGS. 7 and 8 of the drawings, the number of the stationary blind 21 and adjustable blind 22 may vary. For instance, the two stationary blinds 21 may be located between two neighboring adjustable blinds 22. Thus, the first location of the blind element 20 from the bottom of the window blind at a position above the lower support 10 can be the adjustable blind 22, while the second and third locations are the stationary blinds 21, so that one or more stationary blinds 21 may be provided between two adjustable blinds 22.

Before adjusting the blind elements 20, the light permitting range 24 between the stationary blind 21 and adjustable blind 22 may be the same. In other words, the stationary and adjustable blinds 21, 22 are evenly distributed between the upper and lower supports 12, 10 when the first controlling cord set 30 is not pulled. When the first controlling cord set 30 is pulled, all the adjustable blinds 22 are able to be upwardly moved at the same time to adjust the distance between the stationary and adjustable blinds 21, 22. Therefore, if take two stationary blinds 21 and two adjustable blinds 22 as a group, the relatively smaller light permitting range 27 between the lower adjustable blind 22 and upper stationary blind 21 is formed therebetween. The light permitting range 24 between two stationary blinds 21, which are not being controlled by the first controlling cord set 30, is remained the same due to no movement of two stationary blinds 21. The light permitting range 28 between the upper adjustable blind 22 and lower stationary blind 21 is relatively larger. Therefore, three different sizes of the light permitting ranges 24, 27, 28 are selectively and adjustably provided for providing variety of light effect through the window blind.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A window blind, comprising:
an upper support;
a lower support;
a plurality of blind elements spacedly supported between said upper and lower supports, wherein said blind elements are configured to have a plurality of stationary blinds and a plurality of adjustable blinds alternating with said stationary blinds; and
a blind controlling arrangement, which comprises:
a first controlling cord set coupling between said upper and lower supports through said blind elements;
a second controlling cord set coupling between said upper and lower supports through said blind elements for adjustably controlling all said stationary and adjustable blinds to move between an unfolded position and a folded position; and
a plurality of control members selectively coupling with said first controlling cord to retain said adjustable blinds in position in responsive to said first controlling cord, wherein when said first controlling cord is pulled, only said adjustable blinds are upwardly lifted to adjust a relative distance between said stationary blind and adjustable blind, so as to adjust a light permitting range therebetween.

2. The window blind, as recited in claim 1, wherein each of said control members has an opening which is adapted to elastically and flexibly adjust a diameter size thereof, coupling with said first controlling cord set at a position that said control member is positioned at a bottom side of said respective adjustable blind.

3. The window blind, as recited in claim 2, wherein each of said control members comprises a base body defining said opening thereat with a conical shape and having a plurality of gaps downwardly, radially and evenly formed at an inner surface of said opening, and a clipping aperture defined at the minimum diameter of said opening of said base body, such that said first controlling cord set is coupled at said clipping aperture of said control member.

4. The window blind, as recited in claim 3, wherein said clipping aperture is stretched out to increase its diameter size when said first controlling cord passes therethrough and is flexibly returned to its original form after said first controlling cord passes through said clipping aperture, so as to couple said control member at said first controlling cord.

5. The window blind, as recited in claim 4, wherein each of said control members further comprises at least one engaging element is outwardly and horizontally extended from a peripheral edge of an upper end of said base body to support said bottom side of said respective adjustable blind.

6. The window blind, as recited in claim 2, wherein each of said control members comprises a U-shaped clipping member having a guiding channel provided thereat, wherein said guiding channel has an opened end formed at a peripheral edge of said clipping member and a closed end extended towards a central portion thereof to define a clipping aperture as said opening of said control member at said closed end of said guiding channel.

7. The window blind, as recited in claim 6, wherein said first controlling cord set is coupled at said clipping aperture through said guiding channel to retain said control member at said bottom side of said adjustable blind.

8. The window blind, as recited in claim 2, wherein each of said blind elements has two elongated cord through holes are provided at two end portions of each of said stationary and adjustable blinds to align with said openings of said control members, wherein said first and second controlling cord sets are extended through said cord through hole of each of said blind elements in tandem manner.

9. The window blind, as recited in claim 5, wherein each of said blind elements has two elongated cord through holes are provided at two end portions of each of said stationary and adjustable blinds to align with said openings of said control members, wherein said first and second controlling cord sets are extended through said cord through hole of each of said blind elements in tandem manner.

10. The window blind, as recited in claim 7, wherein each of said blind elements has two elongated cord through holes are provided at two end portions of each of said stationary and adjustable blinds to align with said openings of said control members, wherein said first and second controlling cord sets are extended through said cord through hole of each of said blind elements in tandem manner.

11. The window blind, as recited in claim 1, wherein a bottom free end of said first controlling cord set is extended from said upper support through said blind elements to affix to said adjustable blind at the bottommost location, wherein a bottom free end of said second controlling cord set is extended from said upper support through said blind elements to affix to said lower support.

12. The window blind, as recited in claim 9, wherein a bottom free end of said first controlling cord set is extended from said upper support through said blind elements to affix to said adjustable blind at the bottommost location, wherein a bottom free end of said second controlling cord set is extended from said upper support through said blind elements to affix to said lower support.

13. The window blind, as recited in claim 10, wherein a bottom free end of said first controlling cord set is extended from said upper support through said blind elements to affix to said adjustable blind at the bottommost location, wherein a bottom free end of said second controlling cord set is extended from said upper support through said blind elements to affix to said lower support.

14. The window blind, as recited in claim 11, wherein said stationary blinds and said adjustable blinds have the substantially identical size and shape, and said stationary and adjustable blinds are evenly distributed between said upper and lower supports when said first controlling cord set is not pulled.

15. The window blind, as recited in claim 12, wherein said stationary blinds and said adjustable blinds have the substantially identical size and shape, and said stationary and adjustable blinds are evenly distributed between said upper and lower supports when said first controlling cord set is not pulled.

16. The window blind, as recited in claim 13, wherein said stationary blinds and said adjustable blinds have the substantially identical size and shape, and said stationary and adjustable blinds are evenly distributed between said upper and lower supports when said first controlling cord set is not pulled.

17. The window blind, as recited in claim 15, wherein each of said adjustable blinds is spacedly supported between every two of said neighboring stationary blinds.

18. The window blind, as recited in claim 16, wherein each of said adjustable blinds is spacedly supported between every two of said neighboring stationary blinds.

19. The window blind, as recited in claim 15, wherein every two of said stationary blinds are spacedly located between every two of said neighboring stationary blinds.

20. The window blind, as recited in claim 16, wherein every two of said stationary blinds are spacedly located between every two of said neighboring stationary blinds.
